(19) United States
(12) Patent Application Publication
(10) Pub. No.: US 2004/0255740 A1
(43) Pub. Date: Dec. 23, 2004

(54) Sawdust clearing band saw blade

(76) Inventor: Daniel C. Troyer, Brookville, PA (US)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(21) Appl. No.: 10/601,792

(22) Filed: Jun. 23, 2003

(51) Int. Cl. B26D 1/00

(52) U.S. Cl. 83/13; 83/167; 83/855

(57) ABSTRACT

A dust clearing band saw blade that includes a body having a blade thickness with a blank side and a cutting side. A plurality of spaced teeth having cutting edges are formed on the cutting side of the body, and a blade valley is defined between the adjacent teeth. A cut out is also positioned in front of the cutting edge of each tooth, whereby the cut out extends through the blade thickness and below the blade valley. A method for clearing sawdust from a band saw blade is also disclosed.

### BACKGROUND OF THE INVENTION

1. Field of the Invention

The present invention relates to band saw blades and, more particularly, to devices for clearing dust from band saw blades.

2. Description of Related Art

Conventionally, band saw blades are used on a band saw machine to cut material, such as wood or metallic workpieces. Band saw blades typically have a body portion made of metal, such as steel, with cutting members or teeth arranged in a pattern on one side of the body portion. The teeth can be made of the same material as the body portion or made of a material harder than the body portion. For example, cemented carbide teeth can be brazed onto a steel body portion of a band saw blade. Band saw blades can take on many different thicknesses, tooth patterns, such as height, spacing, and direction, or any other type of pattern in order to cut through various types and sizes of workpieces. Band saw blades are generally more flexible than other types of saw blades.

When a workpiece is being sawn by a band saw blade, chips (often referred to as sawdust when the workpiece is wood) are produced by the sawing action. Once a groove is formed by the sawing action, the sawdust is generally removed by lodging in the spacing or gullet between each tooth and carried out of the groove as the workpiece is being cut. However, discharge of the sawdust through the saw groove becomes difficult when the sawdust is as thick as the saw blade or when the sawdust clumps together. Oftentimes, the sawdust has a tendency to collect in the gullet between each tooth of a conventional band saw blade. Once this gullet is filled with sawdust, the unremoved sawdust can cause the flexible band saw blade to veer to the right or the left while cutting. In addition, when the saw blade continues to cut the workpiece after the sawdust has collected in the gullet, the sawdust becomes tightly compressed whereby the pressure can cause breakage of the saw teeth or freezing of the blade within the kerf. This impedes band saw operations and reduces output of the band saw.

Others have attempted to provide saw blades wherein the workpiece chips are removed when cutting. For example, U.S. Pat. No. 4,827,822 to Yoshida describes a band saw blade having teeth which cut a workpiece and a chips removal channel on one side of the body of the saw blade in a lower part of the gullet. (See FIG. 6(c)). This removal channel is either on the right side of the body of the band saw blade or the left side, which corresponds to the set direction of the teeth.

U.S. Pat. No. 4,461,198 to Grassmann describes a circular saw blade with teeth, a cutting edge extending over the entire thickness of the blade, and a chip space formed between the respective teeth for receiving chips from the cut. The chip spaces are similar to Yoshida, however, in that they alternate on opposite sides of the blade thickness.

U.S. Pat. No. 5,054,354 to Kubis describes a circular saw blade having a series of teeth positioned along the periphery of the saw blade body. The saw blade also has a series of recesses formed in the periphery and a slot extended below the bottom surface of the recess. However, this slot is positioned away from the cutting edge of each tooth.

FIG. 1 of German Patent No. DE3614341A1 shows a circular cutting blade having a set of teeth and a groove below each respective tooth. However, this saw blade tooth pattern is used on a circular saw blade and not on a band saw blade.

Other saw blades are disclosed in U.S. Pat. Nos. 3,022,621 and 6,298,762, and German Patent No. DE3838844.

It is an object of the present invention to overcome these shortcomings of the prior art and to provide a simple, inexpensive, and robust band saw blade which facilitates removing of sawdust from a band saw blade as the blade is cutting the workpiece.

### SUMMARY OF THE INVENTION

The present invention provides for a dust-clearing band saw blade that includes a flexible, longitudinal-extending body having a blade thickness with a blank side and a cutting side, a plurality of spaced teeth having cutting edges formed on the cutting side of the body, and a blade valley defined between adjacent teeth. The band saw blade further includes a cut out having a side wall positioned directly in front of the cutting edge of each tooth, wherein the cut out extends through the blade thickness and below the blade valley. The side wall of each cut out may be formed by the adjacent tooth's cutting edge, wherein the side wall is an extension of the cutting edge below the blade valley.

The invention also includes a method for clearing sawdust from a band saw blade. First, a workpiece is cut by moving the teeth of the saw blade across the surface of the workpiece. Second, a kerf is formed in the workpiece. Third, sawdust formed inside the kerf is directed from the cutting edge of each tooth directly into the adjacent cut out. Fourth, sawdust inside each of the cut outs is carried from the kerf to a location removed from the workpiece. Fifth, the sawdust falls away from the cut outs.

Other details and advantages of the invention will be apparent from the following drawings and description.

### BRIEF DESCRIPTION OF THE DRAWINGS

FIG. 1 is a front elevational view, partially in section, of a band saw blade made in accordance with the present invention;

FIG. 2 is a sectional view taken along lines II-II of the saw blade shown in FIG. 1;

FIG. 3 is a side elevational view of a cutting tooth of the saw blade shown in FIG. 1;

FIG. 4 is a front elevational view of the saw blade shown in FIG. 1;

FIG. 5 is a perspective view of the saw blade shown in FIG. 1;

FIG. 6 is a front elevational view, partially in section, of a band saw blade made in accordance with a second embodiment of the present invention;

FIG. 7 is a sectional view taken along lines VII-VII of the saw blade shown in FIG. 6;

FIG. 8 is a side elevational view of a cutting tooth of the saw blade shown in FIG. 6;

FIG. 9 is an elevational view of the saw blade shown in FIG. 1 cutting a workpiece; and

FIG. 10 is a front elevational view of the saw blade cutting into the workpiece as shown in FIG. 9.

### DETAILED DESCRIPTION OF THE PREFERRED EMBODIMENTS

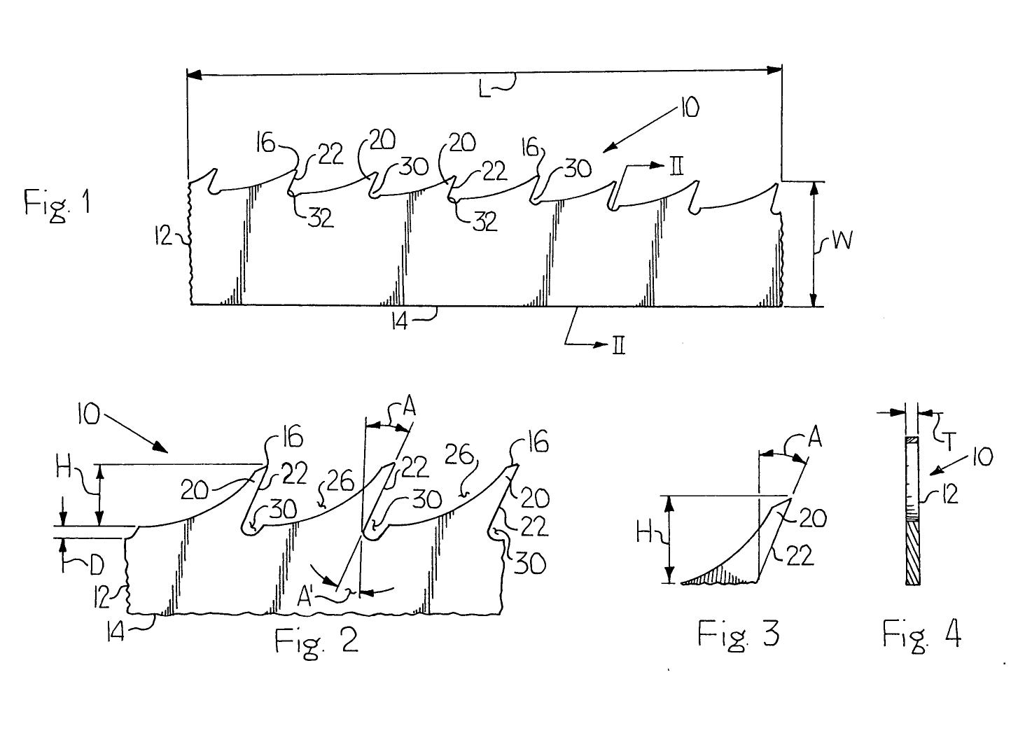

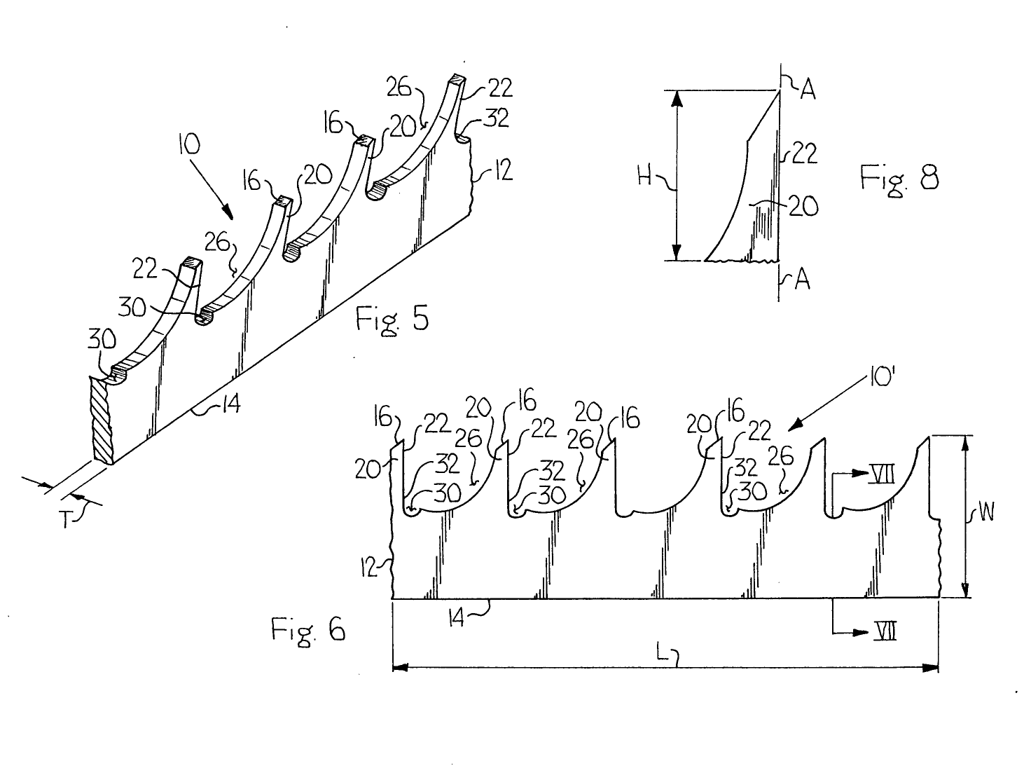

Referring to FIGS. 1-5, the present invention provides for a band saw blade 10 for use in a band saw machine. The band saw machine can be any conventional band saw machine known in the band saw cutting art i.e., hand-held, table mounted, floor mounted, etc. The band saw blade 10 includes a flexible longitudinal-extending body 12 having a blade thickness T, shown in FIG. 4, along with a blank side 14 and a cutting side 16. The body 12 includes a plurality of spaced teeth 20 having cutting edges 22 formed on the cutting side 16 of the body 12, a blade valley or gullet 26 defined between adjacent teeth 20, and a cut out 30 having a side wall 32 positioned in front of the cutting edge 22 of each tooth 20 and extending straight through the blade thickness T below the blade valley 26. The cutting edges 22 extend a length L of the body 12 and can be parallel to each other. Referring to FIGS. 2 and 3, each respective tooth 20 defines a ski-jump shaped profile. The cut out 30, which extends below the blade valley 26, can have a U-shaped profile, wherein the side wall 32 of each cut out 30 is preferably formed by the adjacent tooth cutting edge 22. The side wall 32 may, thus, generally be an extension of the cutting edge 22 below the blade valley 26. The cut out 30 also has an axis, which is perpendicular to the longitudinal axis of the band saw blade 10.

The selection of a tooth pattern is generally determined by the material to be cut. The general factors include tooth form, style, or shape of the teeth, tooth spacing, the number of teeth per inch, and tooth set which provides clearance for the body portion 12 of the saw blade 10. For example, if cutting a fine finish material the number of teeth per inch is high compared to cutting materials that do not require a fine or smooth surface cut. The form of a tooth can be characterized by the “tooth rake angle” which is defined as the angle of the tooth's cutting edge from a perpendicular line (i.e., vertical line) drawn from the blank edge of the band. For example, the greater the tooth rake angle, the easier it is for the blade to penetrate the material due to the self-feeding action of the blade. FIG. 3 shows the teeth 20 having a tooth rake angle A of about 15 degrees. FIGS. 6-8 show another embodiment of a band saw blade 10′, wherein like reference numerals are used for like parts. Band saw blade 10′ can have a tooth rake angle A of 0 degrees. As the tooth rake angle A increases, the teeth 20 become more fragile. Preferably, the tooth rake angle A can range between 0 and 15 degrees.

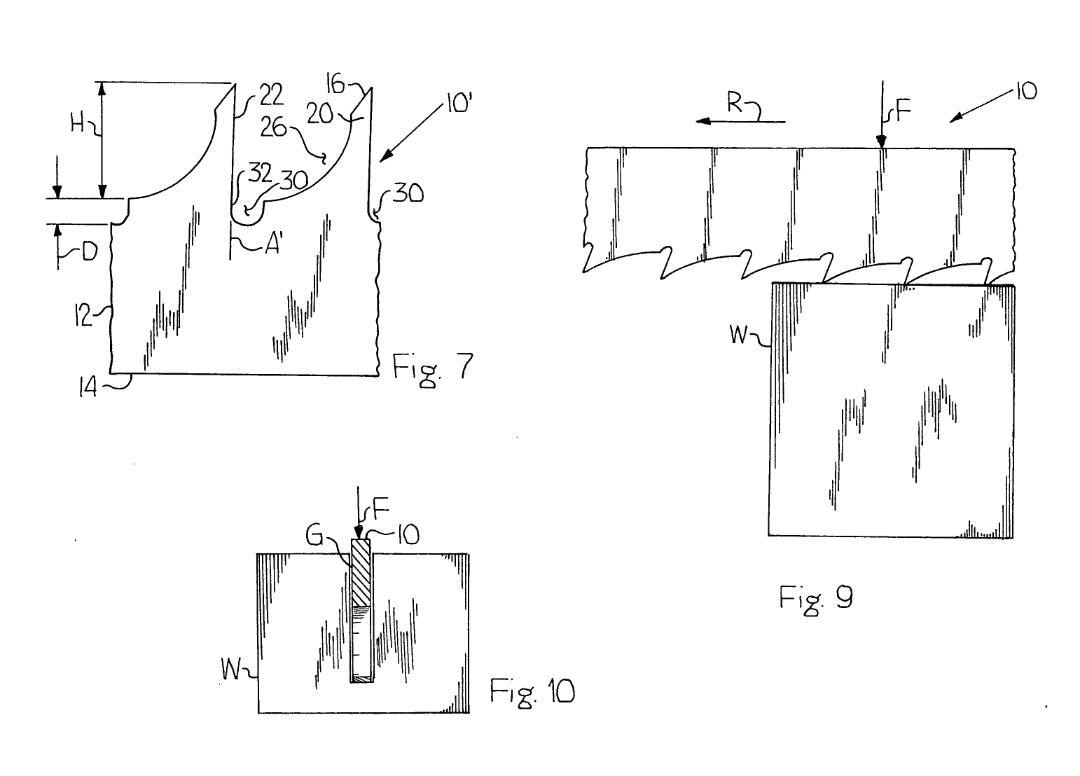

Referring to FIGS. 2 and 7, each cut out 30 can form an angle A′ at an axis bisection ranging between 0 degrees (shown in FIG. 7) to about 15 degrees (shown in FIG. 2) with respect to vertical. The height H of each tooth 20, thickness T, width W, and length L of the saw blades 10, 10′ can vary depending on the material to be cut. However, for maximum sawdust removal, the depth D of the cut out 30 can be approximately equal to the blade thickness T. It is also preferred that the depth D of the cut out 30 be no more than one-half the height H of its adjacent tooth 20.

The saw blades 10, 10′ can be made of a unitary piece of metal or the teeth 20 can be brazed onto the cutting side 16 of the body 12. The body 12 can be made from metal, such as steel, or other suitable substances harder than steel, such as carbide, depending on the material being cut.

In use, the band saw blade 10 is inserted to a band saw machine (not shown). The band saw machine can be any type or size band saw machine typically used in the industry. Referring to FIGS. 9 & 10, the teeth 20 of the saw blade 10 are placed on a workpiece W. The workpiece W to be cut can be wood, synthetic materials or metals. When the workpiece W is being cut, the saw blade 10 moves in a direction R of the cut to cut the workpiece W. The teeth 20 cut into the workpiece W when a downward force F is applied to the saw blade 10, thus forming a groove G (or “kerf”). As the workpiece W is being cut, sawdust is produced. The sawdust is then removed by lodging in the blade valley 26 and the cut out 30 and carried out of the groove G as the workpiece W is being cut. The cut outs 30 act like a sweeper, carrying sawdust from the kerf, instead of the saw dust lodging in the blade valleys 26 and in between the sides of the band saw blade 10 and the walls of the kerf.

Each cut of the workpiece W by a tooth 20 produces sawdust that can collect between the groove G of the workpiece W and a surface of the body portion 12 of the blade 10. This sawdust can become compact and cause resistance to cutting, thereby causing the blade 10 to veer to either the right or the left. The cut out 30 helps to remove further the sawdust from the groove G as it is being produced from the teeth 20. In this way, a build-up of sawdust cannot occur and cause damage to the saw blade 10. Several problems can occur when the sawdust is not properly removed from the groove G. First, the sawdust may become welded to the tooth 20. This will change the form of the tooth 20 which, in turn, will change the amount of force required for the blade to cut. This can result in a dull blade and in an unbalanced blade that can produce a crooked cut. Second, the sawdust can wedge in the groove G. Because the sawdust is work-hardened and harder than the stock from which it came, the blade will cut into the stock beside the sawdust. Again, the result is a crooked cut and a dull blade. For the optimum removal of sawdust while maintaining blade integrity, it is preferred that a cut out 30 have a depth D of no more than about one-half the height H of its adjacent tooth 20. The teeth 20 become more fragile and susceptible to breakage when the depth D of the cut out 30 is greater than one-half the height of the tooth 20.

In one example, a conventional band saw blade without a cut out and the band saw blade 10 were used continuously in a production plant for two weeks on a band saw machine to cut wood. The band saw blade without the cut out became dull quicker and would freeze up due to the large sawdust chips. To prevent the freeze up, the saw blade had to be run at a slower speed, which resulted in less production. When saw blade 10 was used in production, sawdust build-up was practically eliminated and plant production increased an additional 3,500 feet per day.

In general, sawdust is removed from the kerf by lodging in the blade valley between the teeth. The greater the height H of the teeth, the deeper the blade valley becomes, thus allowing more sawdust to lodge in the blade valley and be removed. However, increasing the height of the teeth also increases the amount of sawdust produced. One advantage of having a cut out 30 wherein the sidewall 32 is an extension of the cutting edge 22 of the teeth 20 is that more sawdust can lodge against the cutting edge 22 in the blade valley 26 and the cut out 30, without increasing the amount of sawdust that is produced by the teeth 20. As the cutting edge 22 of the teeth 20 are producing sawdust, the sawdust can more readily lodge into the cut out 30 having the side wall 32 as the cutting edge 22 than when a cut out is spaced away from a cutting edge. This is especially important when the sawdust is in the form of long wavy chips (often referred to as weeds). Depending on the form of the sawdust, a cut out spaced from the cutting edge is more likely to become bridged over with irregularly-shaped sawdust chips than the cut out 30 having a side wall 32 as an extension of the cutting edge 22. Therefore, sawdust is removed more efficiently in saw blade 10 than in a saw blade having a cut out spaced from the cutting edge. Further, the dullness of the teeth 20 also does not impair the capacity or efficiency of the cut out 30 to remove the sawdust, unless the tooth height H is reduced. Cut outs 30 can be installed in a typical band saw blade using a grinding wheel.

Other modifications and alternative embodiments of the invention will be apparent to those skilled in the art, upon reading of the instant specification. It is intended that the invention not be limited to the preferred embodiments described herein, but rather that the invention be limited only by the appended claims.

1. A dust-clearing band saw blade, comprising:
a flexible, longitudinal-extending body having a blade thickness with a blank side and a cutting side;
a plurality of spaced teeth having cutting edges formed on the cutting side of said body;
a blade valley defined between adjacent teeth; and
a cut out positioned in front of the cutting edge of each tooth, said cut out extending through said blade thickness and below said blade valley.

2. The band saw blade as claimed in claim 1, wherein the cut out is U-shaped and positioned directly in front of each tooth.

3. The band saw blade as claimed in claim 1, wherein said cutting edges extend parallel to each other.

4. The band saw blade as claimed in claim 2, wherein a side wall of each cut out is formed by the adjacent tooth's cutting edge.

5. The band saw blade as claimed in claim 4, wherein said side wall is an extension of said cutting edge below said blade valley.

6. The band saw blade as claimed in claim 1, wherein each respective tooth defines a ski-jump shaped profile and each cutting edge defines a tooth rake angle ranging from 0 to 15 degrees.

7. The band saw blade as claimed in claim 1, wherein an axis bisection of each cut out forms an angle ranging from 0 to 15 degrees with respect to vertical.

8. The band saw blade as claimed in claim 1, wherein said cut out has a depth no more than one-half the height of its adjacent tooth.

9. The band saw blade as claimed in claim 1, wherein said cut out has a depth corresponding to said blade thickness.

10. A dust-clearing band saw blade comprising:
a flexible, longitudinal-extending body having a blade thickness with a blank side and a cutting side;
a plurality of spaced teeth having cutting edges formed on the cutting side of said body;
a blade valley defined between adjacent teeth; and
a cut out having a side wall positioned in front of the cutting edge of each tooth, said cut out extending through said blade thickness, wherein said side wall is an extension of said cutting edge below said blade valley.

11. A method for clearing sawdust from a band saw blade when the band saw blade is cutting a workpiece, said band saw blade comprising a plurality of spaced teeth having cutting edges, a blade valley defined between adjacent teeth, and a cut out positioned directly in front of the cutting edge of each tooth, said cut out extending through said blade thickness and below said blade valley, the method comprising:
a. cutting a workpiece by moving the teeth of the saw blade across the surface of the workpiece;
b. forming a kerf in the workpiece;
c. directing sawdust formed inside the kerf from the cutting edge of each tooth directly into the adjacent cut out;
d. carrying sawdust inside the cut outs from the kerf to a location removed from the workpiece; and
e. removing sawdust from the cut outs.
